(19) United States
(12) Patent Application Publication
(10) Pub. No.: US 2016/0003134 A1
(43) Pub. Date: Jan. 7, 2016

(54) SYSTEM FOR SUPERCHARGING THE INTAKE GASES AND FOR RECIRCULATING THE EXHAUST GASES OF AN ENGINE AND ASSOCIATED CONTROL METHOD

(71) Applicant: VALEO SYSTEMES DE CONTROLE MOTEUR, Cergy Saint Christophe (FR)

(72) Inventors: Grégory Hodebourg, Sartrouville (FR); Sébastien Potteau, Triel Sur Seine (FR)

(73) Assignee: Valeo Systemes de Controle Moteur, Cergy Saint Christophe (FR)

(21) Appl. No.: 14/766,647

(22) PCT Filed: Feb. 4, 2014
(86) PCT No.: PCT/FR2014/050200

§ 371 Date: Aug. 7, 2015

(30) Foreign Application Priority Data
Feb. 7, 2013 (FR) 1351054

(51) Int. Cl. F02B 37/18; F02B 29/08; F02B 33/40

(52) U.S. Cl. CPC F02B 37/183; F02B 33/40; F02B 29/08

(57) ABSTRACT

The invention concerns a system (3) for supercharging the intake gases and for recirculating the exhaust gases of an engine (1), comprising: a supercharging circuit (5) comprising a turbocharger (9) to be driven by the exhaust gases from at least a first cylinder (2a, 2b, 2c) of the engine (1); a recirculating circuit (7) for the exhaust gases from at least a second cylinder (2d); and an exhaust gas-orienting device (25) winch is connected to the two circuits (5 and 7) and is intended to be connected to an exhaust line (23) of the engine (1) so as to control an amount of exhaust gas placed in communication between the supercharging circuit (5), the recirculating circuit (7) and the exhaust line (23) of the engine (1).

The present invention relates to the field of combustion engines, in particular engines designed to drive motor vehicles, equipped with an exhaust gas recirculation (EGR) circuit, and in particular engines whereof the exhaust gas recirculating circuit is applied on at least one dedicated cylinder. In other words, the dedicated cylinder is such that its outlet is directly connected to the inlet of the gas recirculating circuit.

It is known from the state of the art to recirculate part of the exhaust gases toward the air intake, in particular in case of low engine load, so as to reduce the quantity of polluting emissions or fuel consumption.

The acceptable limit for the recirculation rate varies for each type of engine (depending on the technology used, the power, the adjustments, etc.) and based on the engine parameters (rating, temperature, etc.). Exceeding the acceptable limit may lead to a loss of efficiency of the engine, and it is therefore appropriate to be able to modify the recirculation rate irrespective of the configuration of the engine. To that end, it is known to introduce a valve at the intake of the dedicated cylinder. Thus, by closing the valve at the intake of the dedicated cylinder, only the non-dedicated cylinders, i.e., the other cylinders, are used, which makes it possible to avoid recirculation of the gases and therefore the loss of engine efficiency related to the recirculation. However, introducing such a valve at the intake of the dedicated cylinder may create a significant vacuum at the dedicated cylinder due to the absence of gas at the intake, which can create losses by pumping. Furthermore, if the engine operates with only part of the cylinders, and in particular cold, this may cause additional vibrations and require the addition of active silent blocks and/or redimensioning of the movable hitch comprising the connecting rods and pistons of the cylinders.

In the case of engines comprising a turbocharger, the turbine of the turbocharger is only driven by the non-dedicated cylinders of the engine, which can be detrimental to the engine performance. In fact, the turbine may not benefit from exhaust gases from the dedicated cylinder to be driven by them.

The aim of the present invention is therefore to contribute to at least partially resolving the aforementioned drawbacks of the state of the art.

The present invention therefore relates to a system for supercharging the intake gases and recirculating the exhaust gases of an engine, said system comprising:

a supercharging circuit comprising a turbocharger to be driven by the exhaust gases from at least a first cylinder of the engine;

a recirculating circuit for the exhaust gases from at least one second cylinder;

an exhaust gas-orienting device that is connected to the two circuits and is intended to be connected to an exhaust line of the engine so as to control an amount of exhaust gas placed into communication between the supercharging circuit, the recirculating circuit and the exhaust line of the engine. In particular, the orienting device is positioned at the output of the cylinders of the engine.

In particular, the first cylinder is a cylinder not dedicated to the recirculation of the gases, i.e., not directly connected to the exhaust gas recirculating circuit; the second cylinder is a circuit dedicated to the recirculation of the exhaust gases, i.e., directly connected to the exhaust gas recirculating circuit.

According to another aspect of the present invention, the gas-orienting circuit is connected to the supercharging circuit at a discharge duct of the turbocharger.

According to an additional aspect of the present invention, the exhaust gas-orienting device comprises:

an exhaust gas recirculation valve comprising a body defining a primary duct designed to be connected on the one hand to the outlet of the at least one second cylinder, and on the other hand to a gas recirculation duct, and an auxiliary duct emerging in said primary duct, said recirculation valve further comprising means for orienting exhaust gases toward the outlet of the primary duct designed to be connected to said gas recirculation duct and/or toward the auxiliary duct,

a discharge valve comprising a cavity having a first opening designed to be connected to a duct connected to the outlet of the first cylinder, a second opening designed to be connected to the exhaust line, and a third opening connected to the auxiliary duct of the recirculation valve, the discharge valve also comprising first and second means for closing off said first and second openings, respectively, to control the placement in communication of the auxiliary duct with the duct connected to the first and second openings.

According to an additional aspect of the present invention, the exhaust gas-orienting means of the recirculation valve comprise a shutter movable between a full recirculation position preventing the communication between the primary duct and the auxiliary duct and a second position closing off the primary duct, allowing the placement in communication of the primary duct and the auxiliary duct.

According to an additional aspect of the present invention, the system also comprises an air cooler designed to be situated upstream from the intake of the cylinders of the engine and situated downstream from an intake of the gas recirculating circuit, said cooler being configured to cool and mix the gases received at the inlet to transmit the cold and mixed gases toward the cylinders of the engine.

The embodiments of the present invention also relate to a method for controlling a system according to the invention, in which the exhaust gas-orienting device is steered to control an amount of gas placed in communication between the supercharging circuit, the recirculating circuit and the exhaust line of the engine.

According to another aspect of the present invention, the exhaust gas-orienting device is steered based on the parameters of the engine.

According to an additional aspect of the present invention, the steering of the gas-orienting device comprises the steering of the exhaust gas-orienting means of the recirculation valve and the steering of the first and second closing means of the discharge valve.

According to another aspect of the present invention, the method comprises a step in which the orienting means orient the gases toward the primary duct and the first closing means close the first opening of the discharge valve so as to isolate the supercharging and gas recirculating circuits relative to one another.

According to an additional aspect of the present invention, the method comprises a step in which the orienting means orient the gases toward the primary duct and the closing means of the discharge valve are in the open position so as to isolate the supercharging and gas recirculating circuits relative to one another and allow a discharge of the gases driving the turbocharger toward the exhaust line.

According to another aspect of the present invention, the method comprises a step in which the orienting means orient the gases toward the auxiliary duct and the second closing means of the discharge valve close the second opening so as to isolate the gas-orienting device of the exhaust line and place the gases from the second cylinder in communication with the gases driving the turbocharger, said turbocharger then being driven by the first and second cylinders.

According to an additional aspect of the present invention, the method comprises a step in which the orienting means orient the gases toward the auxiliary duct, and in which the first closing means of the discharge valve close the first opening so as to isolate the recirculation and supercharging circuits and allow transmission of the gases from the second cylinder toward the exhaust. In particular, the second opening is open.

According to an additional aspect of the present invention, the method comprises a step in which the orienting means orient the gases from the second cylinder toward the primary duct, and in which the second closing means of the discharge valve close the second opening so as to isolate the orienting device from the exhaust line and to facilitate the maintenance in the full recirculation position of the exhaust gas-orienting means of the recirculation valve. In particular, the first opening is open. The orienting means are in particular in the full recirculation position.

According to another aspect of the present invention, the method comprises a step in which the orienting means orient the gases both toward the primary duct and toward the auxiliary duct, and in which the second closing means of the discharge valve close the second opening so as to isolate the orienting device from the exhaust line and place the gases from the second cylinder in communication with the gases driving the turbocharger.

Other features and advantages of the invention will appear in the following description provided below, in reference to the appended drawings, which show, for information the non-limitingly, possible embodiments.

In these drawings:

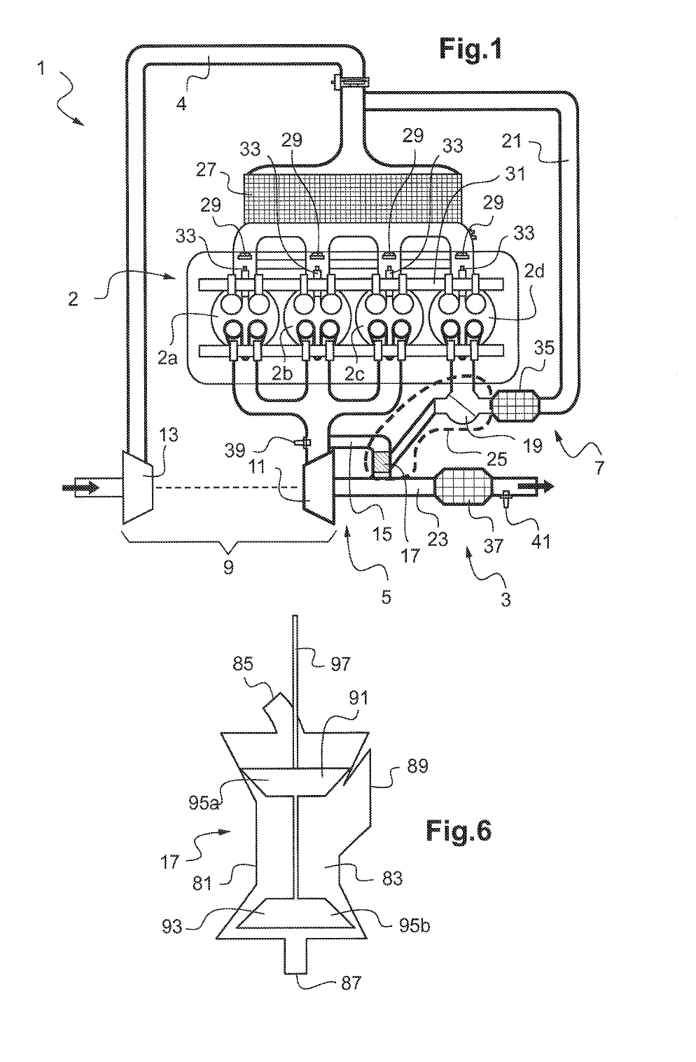

FIG. 1 shows a diagram of part of an engine according to one embodiment of the present invention;

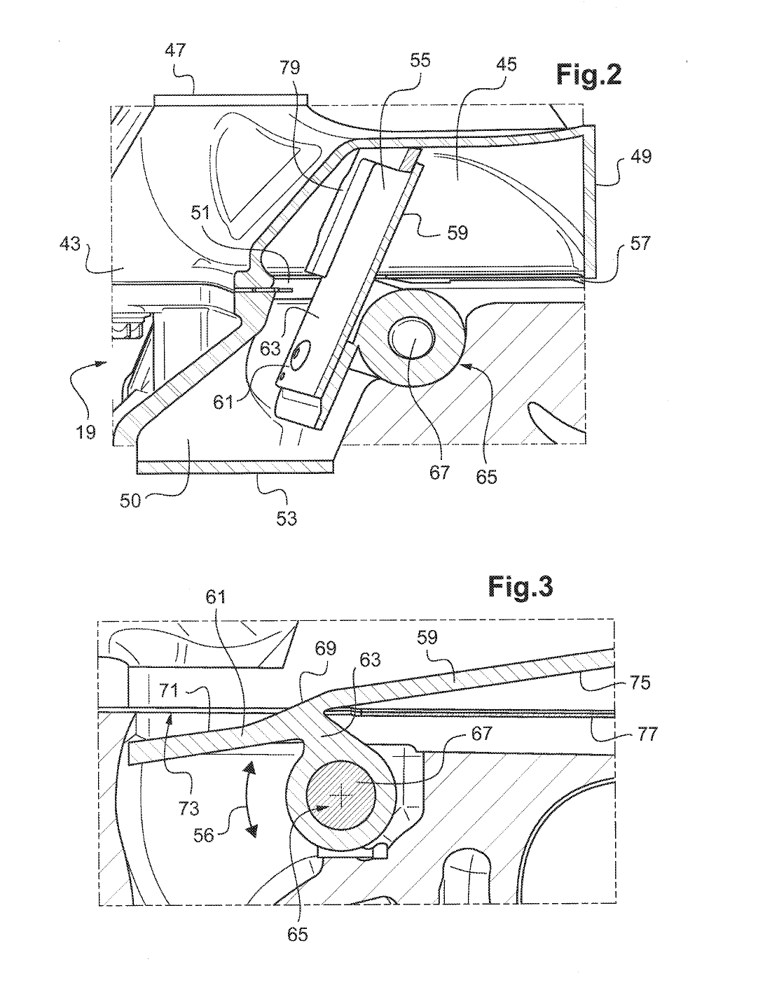

FIGS. 2 and 3 show sectional views of recirculation valves according to different embodiments of the present invention;

FIG. 4 shows a sectional view of the recirculation valve of FIG. 2, the section being done parallel to the axis of rotation of the moving shutter;

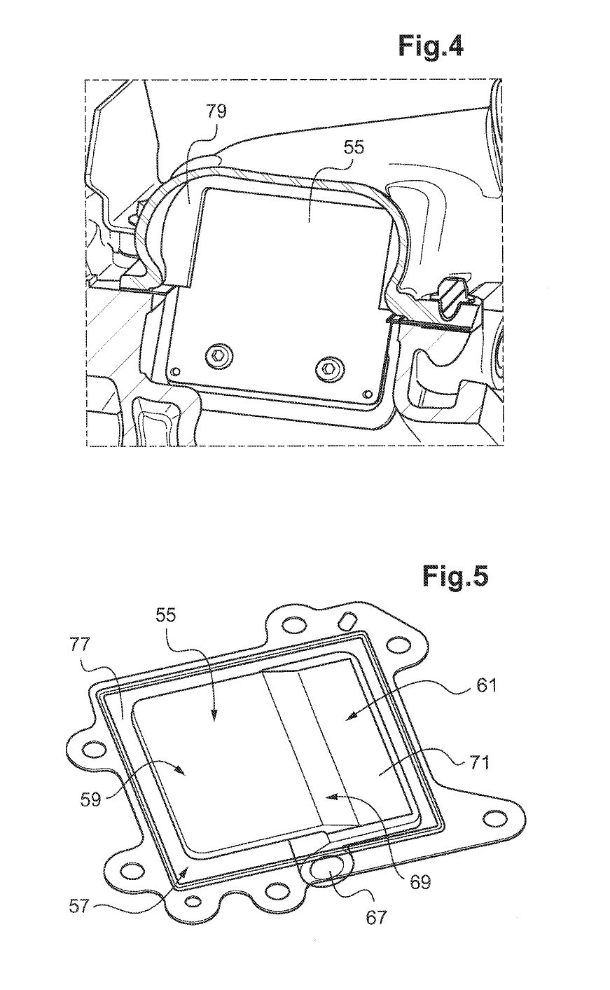

FIG. 5 shows a detailed view of a moving shutter and its insertion at the recirculation valve of FIG. 3;

FIG. 6 shows a diagram of a discharge valve according to one embodiment of the present invention;

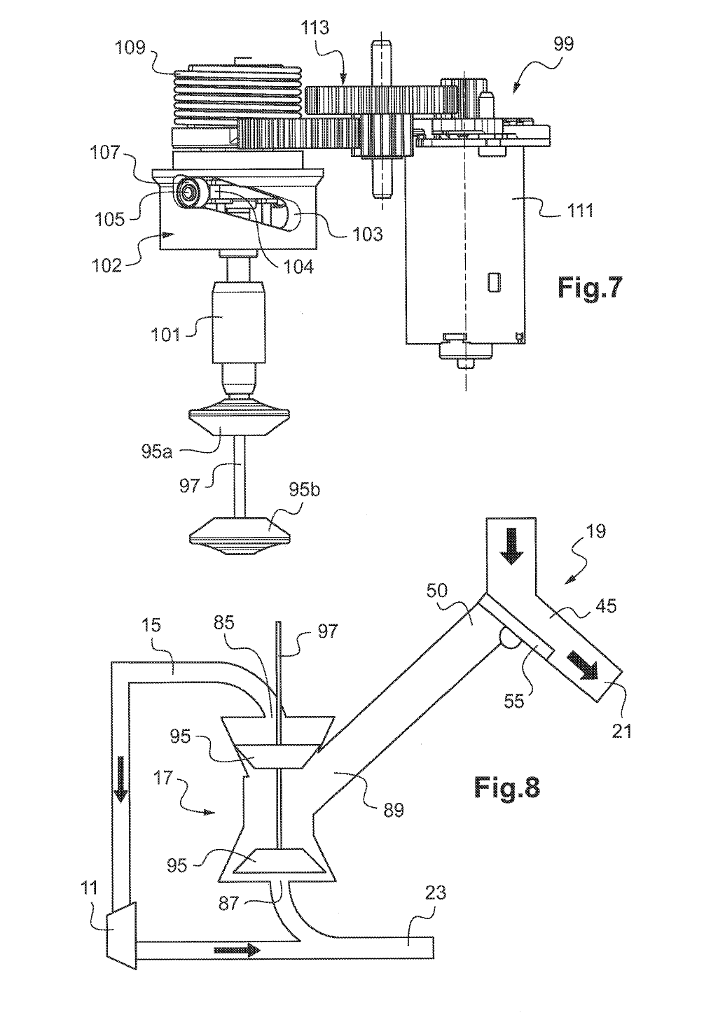

FIG. 7 shows a diagram of an example of actuating means of the closing means of the discharge valve of FIG. 6;

FIGS. 8, 9, 10, 11, 12, 13 and 14 show different configurations of the exhaust gas-orienting device according to one embodiment of the invention.

In these figures, the same reference numbers designate identical elements. Furthermore, for the references including a number and a letter, the number refers to the class comprising all of the elements, while the letter refers to a specific element of that class of elements. For example, reference 2 refers to the set of cylinders, while reference 2a refers to a specific cylinder.

In the following description, the terms below generally refer to:

“Bypass”: the action of deviating a flow from a primary circuit using a bypass channel in order to avoid equipment of the primary circuit;

“Cylinder inlet”: the part of the cylinder where the air intake occurs, for example at the intake gate of the gases designed to be burned.

“Cylinder outlet”: the part of the cylinder where the discharge of the gases occurs, for example at the discharge gate of the gases to discharge the burned gases toward the exhaust.

“Exhaust gas”: the burned gases discharged at the outlet of the cylinders. The exhaust gases may either be oriented toward the exhaust line or recirculated toward the inlet of the cylinders, in particular in the case of the dedicated cylinder.

The embodiments of the present invention in particular relate to a system for supercharging intake gases and recirculating exhaust gases.

FIG. 1 shows an engine 1 comprising one example of such a system 3. In the illustrated example, the engine 1 comprises four cylinders 2 respectively denoted 2a, 2b, 2c, 2d. A cylinder 2d is a cylinder dedicated to the recirculation of the gases such that the gases from the cylinder dedicated to the recirculation of the gases 2d are recirculated by a recirculating circuit 7 that will be described in more detail below. One thus obtains a total amount of recirculated gases very close to 25% in the case of the engine 1 comprising four cylinders 2, including one dedicated cylinder 2d as in FIG. 1.

The system 3 also comprises a supercharging circuit 5 including a turbocharger 9. The turbocharger 9 on the one hand comprises a turbine 11 supplied by the exhaust gases from the cylinders 2 of the engine, and on the other hand, a compressor 13 driven by the turbine to compress the air designed to supply the cylinders 2 at the air intake inlet. The supercharging circuit 5 also comprises a discharge duct 15 that allows the gases from at least one first cylinder 3, three in the present example, and corresponding to the non-dedicated cylinders 2a, 2b and 2c, to bypass the turbine 11 of the turbocharger 9.

The recirculating circuit 7 comprises a recirculation duct 21 configured to orient the gases from the cylinder dedicated to the gas recirculation 2d toward the intake.

An exhaust gas-orienting device 25 connected to the supercharging circuit 5, the recirculating circuit 7 and the exhaust line 23 of the engine 1 makes it possible to control the amount of gas placed in communication between the supercharging circuit 5, the recirculating circuit 7 and the exhaust line 23. The orienting device 25 makes it possible, inter alia, to deviate the gases from the dedicated cylinder 2d so that they contribute to driving the turbine 11 of the turbocharger 9, or to deviate the gases from the non-dedicated cylinders 2a, 2b, 2c to contribute to placing the exhaust gas recirculating circuit 7 in the full recirculation position.

The device 25 may comprise a recirculation valve 19 and a discharge valve 17. The discharge 17 and recirculation 19 valves are respectively positioned in the discharge duct 15 and the recirculation duct 21. When the discharge valve 17 is open, the gases from the non-dedicated cylinders 2a, 2b, 2c and passing through the discharge duct 15 can go directly toward the exhaust line 23. The recirculation valve 19 is placed at the outlet of at least one second cylinder corresponding to the cylinder dedicated to the recirculation of the gases 2d. The recirculation valve 19 is configured to orient the gases from the dedicated cylinder 2d either toward the intake via the recirculation duct 21 or toward the exhaust line 23 via the discharge valve 17.

It should be noted that FIG. 1 shows an example embodiment using the recirculation valve 19 and the discharge valve 17, but the recirculating circuit 7 and the recirculation valve 19 could be inserted into a different architecture not comprising a supercharging circuit 5. In that case, the recirculation valve 19 would be directly connected to the exhaust line 23. Likewise, the discharge valve 17 could be used in a different architecture.

The system 3 can also comprise a supply air cooler 27, for example a water-cooled charged air cooler (WCCAC), that is situated at the intake downstream from the inlet of the recirculation duct 21 and upstream from the cylinders 2. Thus, the cooler 27 makes it possible to cool the outside gases from the turbocharger 9 that were heated by the compression experienced at the compressor 13 on the one hand, and the recirculated gases from the cylinder dedicated to the recirculation of the gases 2d on the other hand, which makes it possible to use only one cooler 27 to cool all of the gases received at the inlet of the cylinders 2.

Furthermore, the use of such a cooler 27 makes it possible to combine the recirculated gases and the outside gases so as to supply the cylinders 2 with a homogenous gas, such that the concentration of recirculated gases will be the same for all of the cylinders 2. To that end, the cooler 27 may comprise disruptors designed to distribute the gases around the channels in which the water flows. These disruptors are for example made by small fins and thus contribute to obtaining a homogenous mixture at the outlet of the cooler 27.

The cylinders 2 may also each comprise an injector 29, for example an injector of the multipoint type, a high-energy ignition coil 31 (which may be shared by the various cylinders) and a spark plug 33. The engine 1 may also comprise a heat exchanger, for example a water gas shift (WGS) catalyst 35 at the recirculation duct 21, a three-way catalyst 27 at the exhaust line 23, a heated exhaust gas oxygen (HEGO) sensor 39 at the outlet of the cylinders 2a, 2b and 2c and an exhaust gas oxygen sensor 41 at the exhaust line 23.

The overall operation of the system 3 for supercharging the intake gases and recirculating the exhaust gases of the engine 1 will now be described in detail relative to the diagram of FIG. 1. The outside air is received at the compressor 13, which compresses it when the turbine 11 of the turbocharger 9 is supplied by the exhaust gases at the output of the cylinders 2. The air is next transmitted toward the intake via an intake duct 4. When the turbine 11 is not supplied by the exhaust gases of the outlet of the cylinders 2, the outside air is then received at the intake duct without being compressed by the compressor 13.

At the intake, the air is mixed with the recirculated gases from the recirculation duct 21 when the orienting device 25 allows recirculation of the exhaust gases. This is in particular the case when the recirculation valve 19 is in the gas recirculation position. The mixture of outside air and recirculated gases is next cooled in the heat exchanger 27, in particular to reduce the number of particles emitted. Furthermore, the heat exchanger contributes to obtaining a homogenous mixture.

The mixture next arrives at the cylinders 2, where it is mixed with the fuel sprayed by the injectors 29, the whole being ignited using spark plugs 33. Once burned, the gases are expelled toward the outlet of the cylinders 2 so as optionally to be oriented by the device 25. In particular, at the dedicated cylinder 2d, based on the position of the recirculation valve 19, the gases from the dedicated cylinder 2d are either completely recirculated toward the intake, or completely oriented toward the discharge valve 17, or part is recirculated and part is oriented toward the discharge valve 17. Depending on the position of the discharge valve 17, the part of the gases from the dedicated cylinder 2d and transmitted to the discharge valve 17 is either used to supply the turbine 11 of the turbocharger 9, or transmitted directly to the exhaust line 23. The gases from the other cylinders 2a, 2b and 2c are either used to supply the turbine 11 of the turbocharger 9 or transmitted directly to the exhaust based on the configuration of the discharge valve 17.

One example recirculation valve 19 according to the invention will now be described in more detail using FIGS. 2 to 5.

The recirculation valve 19 comprises a valve body 43 that defines a primary duct 45 connected on the one hand to the outlet of the cylinder dedicated to the recirculation of the gases 2d via an inlet orifice 47, and on the other hand to the recirculation duct 21 via an outlet orifice 49. The valve body 43 also describes an auxiliary duct 50 emerging in the primary duct 45 through a passage window 51.

The recirculation valve 19 further comprises gas-orienting means that make it possible to control the amount of recirculated gases so as to avoid smothering the engine 1. The orienting means may include a moving shutter 55 at the connection between the primary duct 45 and the auxiliary duct 50. However, it should be noted that other orienting means known by those skilled in the art can also be used, for example a set of flaps situated at the primary duct and the auxiliary duct.

FIGS. 2 and 3 show a sectional view of the recirculation valve 19 in which the section is taken along the length of the shutter 55, while FIGS. 4 and 5 show front views of the shutter 55. The moving shutter 55 is configured to be able to rotate and tilt between a first, full recirculation position and a second position closing off the primary duct 45, as shown in FIG. 2. The moving shutter 55 can occupy any intermediate position between the full recirculation position and the position closing off the primary duct 45. The rotation of the moving shutter 55 is shown by arrow 56 in FIG. 3.

In the full recirculation position, the moving shutter 55 closes the passage window 51 and prevents the placement of the auxiliary duct 55 and the primary duct 45 in communication.

In the position closing off the primary duct 45, the upstream part of the primary duct 45, i.e., the part of the primary duct 45 situated between the inlet orifice 47 and the connection with the auxiliary duct 50, is placed in communication with the auxiliary duct 55, while the downstream part of the primary duct 45, i.e., the part situated between the connection with the auxiliary duct 50 and the outlet orifice 49, is closed off.

In FIG. 3, the shutter 55 is in an intermediate position between the full recirculation position and the position closing off the primary duct 45.

A seal 57 having an opening corresponding with the passage window 51 is positioned at the connection between the primary duct 45 and the auxiliary duct 50 to ensure tightness between the two ducts 45 and 50 when the moving shutter 55 is in the full recirculation position. The seal 57 can be a protruding seal that is maintained between two flanges and that protrudes toward the inside of the ducts 45 and 50. Thus, when the moving shutter 55 comes, in the full recirculation position, into contact with the seal 57, it makes it possible to produce tightness between the two ducts 45 and 50. The use of a sealing gasket 57 makes it possible to obtain a tightness close to 100% in the full recirculation position, which allows precise control of the amount of recirculated gases. Thus, in the application example illustrated in FIG. 1, practically all of the gases from the dedicated cylinder 2d are recirculated when the moving shutter 55 is in the full recirculation position, and one thus obtains a constant recirculated gas rate, for example 25% in the case of a four-cylinder engine whereof one of the cylinders is dedicated to recirculation.

The moving shutter 55 has a so-called closing wing 59 and a bypass wing 61 connected to one another by an intermediate zone 63, said closing 59 and bypass 61 wings being positioned on either side of the sealing gasket 57, while the intermediate zone 63 crosses through the opening of the seal 57. The two wings 59 and 61 come into contact with the sealing gasket 57 in the full recirculation position. The moving shutter 55 also comprises, near the intermediate zone 63, a hinge pin 65 that allows the moving shutter to rotate between the full recirculation position and the closing position of the primary duct 45. The hinge pin 65 is off-centered relative to the closing 59 and bypass 61 wings. The hinge pin 65 is for example formed by an articulation shaft 67 that is fastened at its ends and around which the shutter 55 is guided in rotation. Alternatively, the hinge pin 65 may be secured to the shutter 55 and guided in rotation by bearings situated at both ends of the hinge pin 65.

The dimensions of the wings 59 and 61 along the hinge pin 65 of the shutter 55 may be different from one another and different from the hinge pin 65 itself. Furthermore, in a first embodiment, the closing 59 and bypass 61 wings may be aligned as shown in FIGS. 2 and 4, while in a second embodiment shown in FIGS. 3 and 5, the closing 59 and bypass 61 wings may be parallel but not aligned, i.e., belong to different planes to favor the tightness of the seal 57. In this second embodiment, the intermediate zone 63 may comprise an inclined surface 69. Thus, in the full recirculation position, the upper face 71 of the bypass wing 61 comes in contact with a first part 73 of the seal 57 and the lower face 75 of the closing wing 59 comes into contact with a second part 77 of the seal 57.

The primary duct 45 may also comprise a peripheral stop 79 positioned on the perimeter of the primary duct 45 at the connection with the auxiliary duct 50 such that in the closing position of the primary duct 45, the closing wing 59 bears on the peripheral stop 79. In particular, the stop 79 is thus in line with the closing wing 59, the peripheral edges of the three outer sides of the closing wing 59 then being in contact with the peripheral stop 79. The presence of the peripheral stop 79 thus makes it possible to ensure greater than 95% sealing between the upstream part and the downstream part of the primary duct 45 in that position. Nearly all of the gases are then transmitted toward the auxiliary duct 50.

The peripheral stop 79 is fastened to the primary duct 45, for example by gluing. Furthermore, the height of the peripheral stop 79, i.e., the thickness of the stop in the primary duct 45, will be limited so as to reduce the gas flow rate in the primary duct 45 as little as possible in the full recirculation position of the shutter 55.

At the connection between the primary duct 45 and the auxiliary duct 50, the sections of the ducts are, for example, substantially rectangular, as are those of the closing 59 and bypass 61 wings.

The recirculation valve 19 is also provided with means for actuating the moving shutter 55 in the full recirculation position or the closing position of the primary duct 45 or in an intermediate position. The intermediate positions correspond to the positions for which the upstream part of the primary duct 45 is in communication both with the downstream part of the primary duct 45 and with the auxiliary duct 50. In fact, depending on the configuration and the parameters of the engine 1, it may be necessary to recirculate only part of the gases from the dedicated cylinder 2d to optimize the output at certain operating points of the engine, the other part of the gases being oriented in the auxiliary duct, for example toward the exhaust. These actuating means for example comprise an electric motor and a gear system making it possible to steer the position of the shutter 55 from the electric motor.

Furthermore, the recirculation valve 19 may also comprise an elastic mechanical means, for example a spring, configured to exert a return force on the shutter 55 toward the closing position of the primary duct 45. Thus, in case of nonoperation or failure of the means for actuating the shutter 55, said shutter 55 is positioned by default in the closing position of the primary duct 45, which corresponds to operation without exhaust gas recirculation and makes it possible to be able to operate the engine correctly at all of its operating points.

The use of such a recirculation valve 19 positioned at the outlet of the dedicated cylinder 2d therefore makes it possible to use a single valve to orient the gases from the dedicated cylinder 2d toward the recirculation duct 21 or toward the exhaust. The recirculation valve 19 makes it possible to allow or interrupt the recirculation of the exhaust gases from the dedicated cylinder 2d. In the prior art, this function is performed by a valve situated upstream from the dedicated cylinder 2d at the intake, which creates vacuum problems at the intake and losses due to pumping. The position of the recirculation valve 19 at the outlet of the dedicated cylinder 2d makes it possible to avoid these problems.

Furthermore, the use of a peripheral stop 79 at the primary duct 45 makes it possible to obtain sealing exceeding 95% in the closing position of the primary duct 45. This makes it possible, during a use combined with the discharge valve 17 that will be described in more detail in the continuation of the description, to be able to supply the turbine 11 of the turbocharger 9 with nearly all of the gases coming from the cylinder dedicated to the recirculation of the gases 2d when the discharge valve 17 is configured to that end.

Lastly, configuring the closing means, in particular the shutter 55, so that its default position is the closing position of the primary duct 45 makes it possible to avoid blocking in the full recirculation position in case of failure of the means for actuating the recirculation valve 19.

Furthermore, it should be noted that the embodiments of the present invention are not limited to an engine 4 with four cylinders 2 comprising a dedicated cylinder 2d, but also extend to engines having a different total number of cylinders and/or dedicated cylinders. For example, the engine may comprise two dedicated cylinders whereof the gases are oriented toward a recirculation valve 19 shared by the two dedicated cylinders or the use of two recirculation valves 19 to respectively orient the gases from the respective dedicated cylinders. Furthermore, FIG. 1 shows an example application of the recirculation valve 19, but the recirculation valve 19 can also be used in other architectures comprising recirculation of the gases on a dedicated cylinder.

An example discharge valve 17 according to the invention will now be described in reference to FIGS. 6 and 7. The discharge valve 17 comprises a body 81 defining a cavity 83, for example with a tubular shape, comprising a first 85, second 87 and third 89 opening designed each to be connected to a respective duct. In particular, the first opening 85 is situated at a first end of the cavity 83. The second opening 87 is situated at the other end of the cavity 83. The third opening 89 is situated on the side wall of the cavity 83. In the specific application example illustrated in FIG. 1, the first opening 85 is connected to the outlet of the non-dedicated cylinders 2a, 2b and 2c via the discharge duct 15 of the turbocharger 9, the second opening 87 is connected to the exhaust line 23 and the third opening 89 is connected to the auxiliary duct 50 of the recirculation valve 19.

The discharge valve 17 also comprises first 19 and second 93 closing means that may close off the first 85 and second 87 openings, respectively, so as to control the placement in communication of the ducts connected to the openings of the discharge valve 17.

The closing means 91 and 93 are made, for example, by first 95a and second 95b gates mounted on a shared guide axis 97 as shown in FIG. 6. The guide axis 97 is translatable between a first position in which the first gate 95a closes the first opening 85 and a second position in which the second gate 95b closes the second opening 87. The guide axis can also assume an intermediate position in which the first 95a and second 95b gates do not close the first 85 or second 87 openings. In fact, when the guide axis 97 is in the first position as shown in FIG. 6, the first gate 95a presses on the wall of the body 81 of the discharge valve 17 to prevent the communication between the cavity 83 and the duct connected to the first opening 85. Likewise, in the second position, the second gate 95b comes in contact with the valve body 81 to prevent the communication between the cavity 83 and the duct connected to the second opening 87. The guide axis 97 is for example a rod combined with a central axis of the closing means.

A seal may also be placed between the wall of the valve body 81 and the gates 95a and 95b to ensure good sealing in the closed position. The gates 95a and 95b can be made integrally with the guide axis 97 or can be mounted on the axis and kept in position, for example using gripping collars or by welding.

The discharge valve 17 can also comprise actuating means 99 for the guide axis 97 that make it possible to control the opening or closing of the gates 95. One example embodiment of the actuating means 99 is shown in FIG. 7 with the guide axis 97 and the gates 95a and 95b. The guide axis 97 is mounted translatably on a fixed bearing 101. The axis 97 is secured in translation with a rod 104, also called T-bar, that extends perpendicular to the guide axis 97. The T-bar 104 comprises a retaining stud 105 and a wheel 107 fastened at its end and rotatable around the T-bar 104. The wheel 107 is inserted into a cam 103 such that the rotation of the T-bar 104 around an axis corresponding with the guide axis 97 causes the wheel 107 to move in the cam 103, and drives the translational movement of the axis 97. The rotational movement of the T-bar 104 is controlled by an electric motor 111 via a gear system 113. The rotation of the electric motor drives the rotation of the gears 113, which cause the T-bar 104 to pivot. The actuating means can comprise an elastic means configured so that in the absence of the actuation of the motor 109, the T-bar 104 returns to its idle position at one of the ends of the cam 103 corresponding to one of the extreme positions of the guide axis 97, i.e., either in the closing position of the first opening 85 of the discharge valve 17, or in the closing position of the second opening 87 of the discharge valve 17. For example, the return to the idle position is caused by the spring 109 previously compressed by the gears 113.

Thus, the rotational driving of the element 104 by the electric motor 111 causes the movement of the retaining step 105 and wheel 107 along the cam 103 and drives the translational movement of the guide axis 97 between the first and second positions. However, the embodiments of the present invention are not limited to the actuating means described above, but to all actuating means known by one skilled in the art.

Furthermore, according to an alternative embodiment, the gates 95 can be actuated independently of one another. Furthermore, the gates 95 can also be replaced by flaps that close the first 85 and second 87 openings.

Such a discharge valve 17 thus makes it possible to control the placement in communication of the various ducts connected to its openings 85, 87 and 89. In particular, in the system illustrated in FIG. 1, the discharge valve contributes to controlling the orientation of the gases from the different cylinders 2. Thus, when the first closing means 91 close the first opening 85, the discharge duct 15 is closed off and the gases from the non-dedicated cylinders 2a, 2b and 2c supply the turbine 11 of the turbocharger 9. When the first 91 and second 93 closing means leave the first 85 and second 87 openings open, the ducts connected to the openings 85, 87 and 89 of the discharge valve 17 are then placed in communication. Lastly, when the second closing means 93 close the second opening 87, the gases from the first opening 85 can flow toward the third opening 89 or conversely, the gases from the third opening 89 can flow toward the first opening 85, either of these cases being determined by the different gases at the inlet of the first 85 and third 89 openings. However, it should be noted that the applications of the discharge valve 17 are not limited to the architecture shown in FIG. 1, but extend to any discharge duct of a piece of equipment configured to be driven by a fluid.

The recirculation valve 19 and the discharge valve 17 having been described in detail, an exhaust gas-orienting device 25 according to the invention should now be considered comprising the combination of the two valves 17 and 19. In fact, in this device, the two valves 17 and 19 operate synergistically so as to provide additional possibilities for the configuration of the engine, and in particular in the configuration of the system 3 for supercharging the intake gases and recirculating exhaust gases so as to optimize its operation.

For example, the closing means 91 and 93 of the discharge valve 17 are configured to be open or closed in particular based on the configuration of the recirculation valve 19, and in particular based on the position of the orienting means of said recirculation valve 19. Conversely, the orienting means of the recirculation valve 19 can be positioned as a function of the positions of the closing means 91, 93 of the discharge valve 17.

The actuating means of the two valves 17, 19 can further be configured to be steered as a function of the parameters of the engine 1. The parameters of the engine 1 in particular comprise the engine rating, the engine temperature, the pressure at the outlet of the various cylinders 2, the oxygen level at the inlet of the cylinders 2 or the recirculated gas flow rate at the intake. These parameters can for example be measured using dedicated sensors, such as the exhaust gas oxygen sensors 39 and 41, the measurements being processed by processing means such as a microcontroller or microprocessor that manages the various adjustments of the engine 1. The processing means can be configured to control the means for actuating the valves 17 and 19.

For example, if the orienting means of the recirculation valve 19 are in the full recirculation position and if the oxygen level at the inlet of the cylinders is below a predetermined threshold, the processing means steer the orienting means of the recirculation valve 19 so as to go to the closed position of the primary duct 45 or to an intermediate position to cause the oxygen level to rise. The closing means 91 and 93 of the discharge valve 17 are also steered by the processing means to adapt to the position of the orienting means of the recirculation valve 19 and/or also to the other parameters of the engine 1. The processing means are for example programmed based on tests conducted by applying different configurations of the system 3 for supercharging the intake gases and recirculating exhaust gases to the different situations to which the engine may be exposed, and selecting the best configuration for each situation, the different situations being defined by the various parameters of the engine.

It should also be noted that the recirculation 19 and discharge 17 valves described above using FIGS. 2 to 7 are specific examples of valves of the system 3 for supercharging the intake gases and recirculating exhaust gases, and that the latter may also be configured with different valves allowing the recirculation of the exhaust gases and the discharge of the supercharging circuit.

The embodiments of the present invention also relate to a method for controlling the system 3 for supercharging the intake gases and recirculating exhaust gases of the engine 1. The method essentially relates to the steering of the means for orienting the recirculation valve 19 and closing means 91 and 93 of the discharge valve 17. The steering can be done as a function of the parameters of the engine so as to optimize the operation of the engine 1 to allow, inter alia, a maximum output and/or minimal pollution. The orienting and closing means may assume different configurations described below and thus control the quantity of gas exchanged between the supercharging circuit 5, the recirculating circuit 7 and the exhaust line 23.

Different configurations of the exhaust gas-orienting device 25 will now be described in detail using FIGS. 8 to 12. In these figures, the arrows represent the flow direction of the gases.

FIG. 8 shows a first configuration in which the recirculation valve 19 is in the full recirculation position and the first opening 85 of the discharge valve 17 is closed by the first closing means 91. Thus, the supercharging 5 and recirculation 7 circuits of the gases are isolated from one another. The gases from the dedicated cylinder 2d are recirculated toward the intake, while the gases from the other cylinders, i.e., the non-dedicated cylinders 2a, 2b and 2c, are oriented toward the turbine 11 of the turbocharger 9. Such a configuration is for example used during accelerations with low loads.

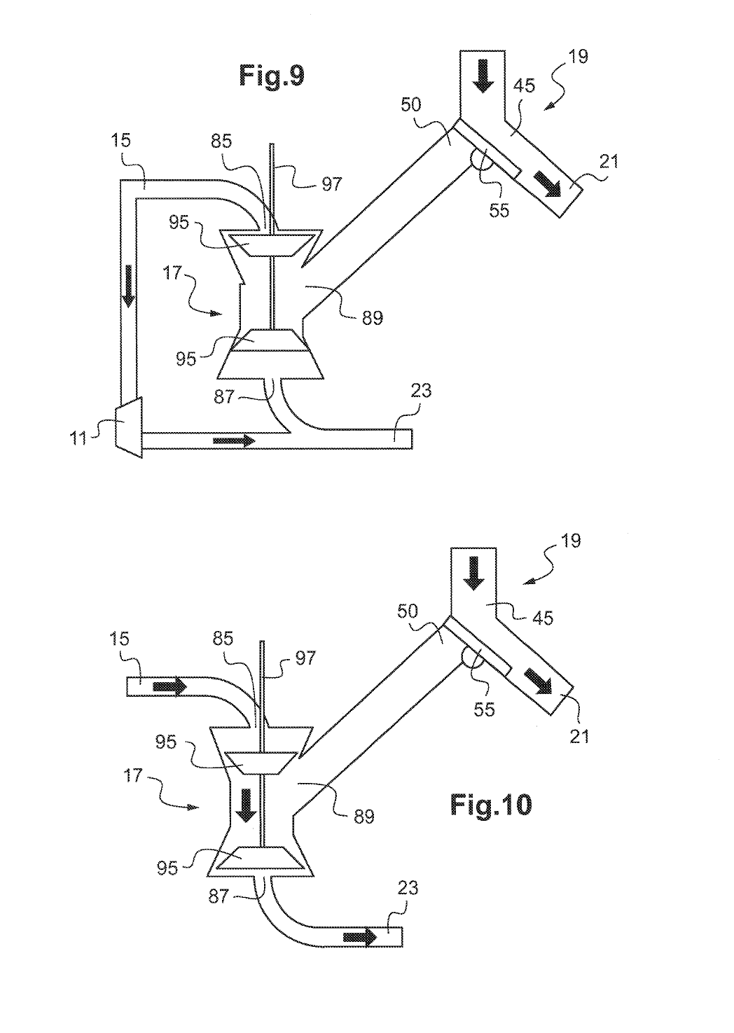

FIG. 9 shows a second configuration in which the recirculation valve 19 is in the full recirculation position, the first opening 85 of the discharge valve 17 is in the open position and the second opening 87 of the discharge valve 17 is in the closed position. The gases from the dedicated cylinder 2d are recirculated toward the intake and the gases from the other cylinders 2a, 2b and 2c are oriented toward the turbine 11 of the turbocharger 9. Unlike the first configuration, the gases from the other cylinders 2a, 2b and 2c make it possible to exert pressure on the moving shutter 55 of the recirculation valve 19 and thus to reduce the force necessary for the actuating means of the moving shutter 55 to keep the shutter 55 in the full recirculation position.

FIG. 10 shows a third configuration in which the recirculation valve 19 is in the full recirculation position and the first 85 and second 87 openings of the discharge valve 17 are in the open position, i.e., the first and second closing means 95 do not close off those openings 85 and 87. The gases from the dedicated cylinder 2d are then recirculated toward the intake and at least part of the gases from the other cylinders 2a, 2b and 2c are sent directly toward the exhaust via the discharge duct 15, bypassing the turbine 11 of the turbocharger 9. Such a configuration may for example correspond to an economical mode making it possible to minimize consumption and polluting emissions of the engine 1.

FIG. 11 shows a fourth configuration in which the recirculation valve 19 is in the closing position of the primary duct 45, the first opening 85 of the discharge valve 17 is in the closed position and a second opening 87 of the discharge valve 17 is in the open position. Thus, the supercharging 5 and recirculation 7 circuits of the gases are isolated from one another and the gases from the dedicated cylinder 2d are sent directly toward the exhaust line 23, while the gases from the other cylinders 2a, 2b and 2c are oriented toward the turbine 11 of the turbocharger 9. Such a configuration may for example be used when there is a need for power, but also a fear of a lack of oxygen at the inlet of the cylinders 2 of the engine, for example due to use at a high altitude.

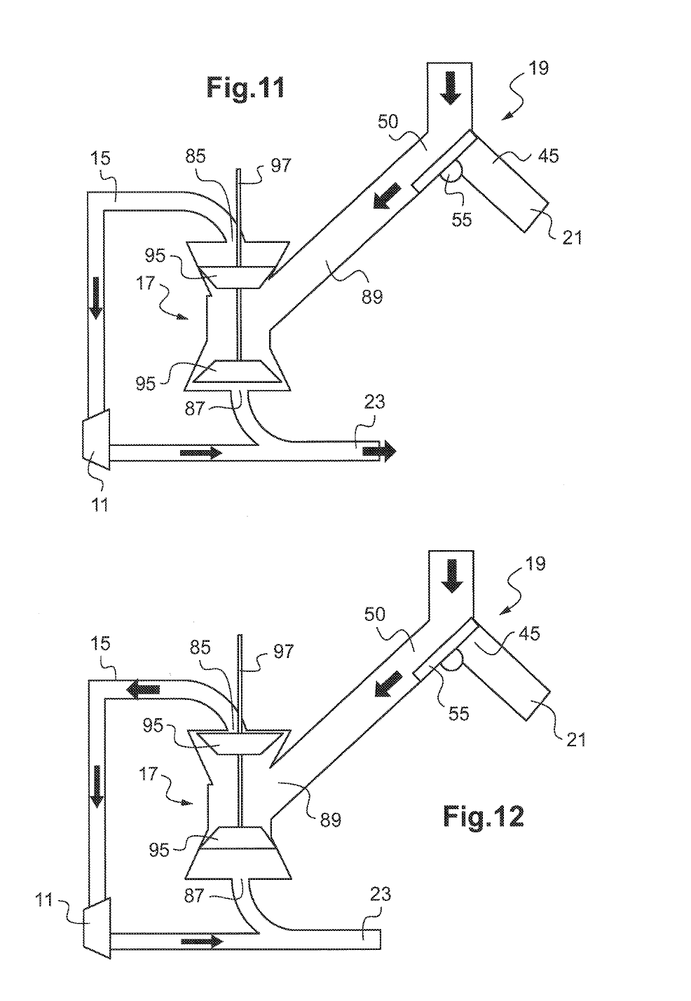

FIG. 12 shows a fifth configuration in which the recirculation valve 19 is in the closing position of the primary duct 45, the first opening 85 of the discharge valve 17 is in the open position and the second opening 87 of the discharge valve 17 is in the closed position. Thus, the gases from the set of cylinders 2 are placed in communication and supply the turbine 11 of the turbocharger 9. Such a configuration may be used cold or when maximum power is sought, for example during high accelerations and at high engine ratings. The configuration of the recirculation 19 and discharge 17 valves therefore makes it possible to supply the turbine 11 of the turbocharger 9 using all four cylinders 2a, 2b, 2c and 2d, which makes it possible to increase the efficiency of the turbocharger 9 and avoid an imbalance that may cause harmful vibrations due to the use of three cylinders 2a, 2b and 2c to supply the turbine 11 of the turbocharger 9, in particular when the engine 1 is cold.

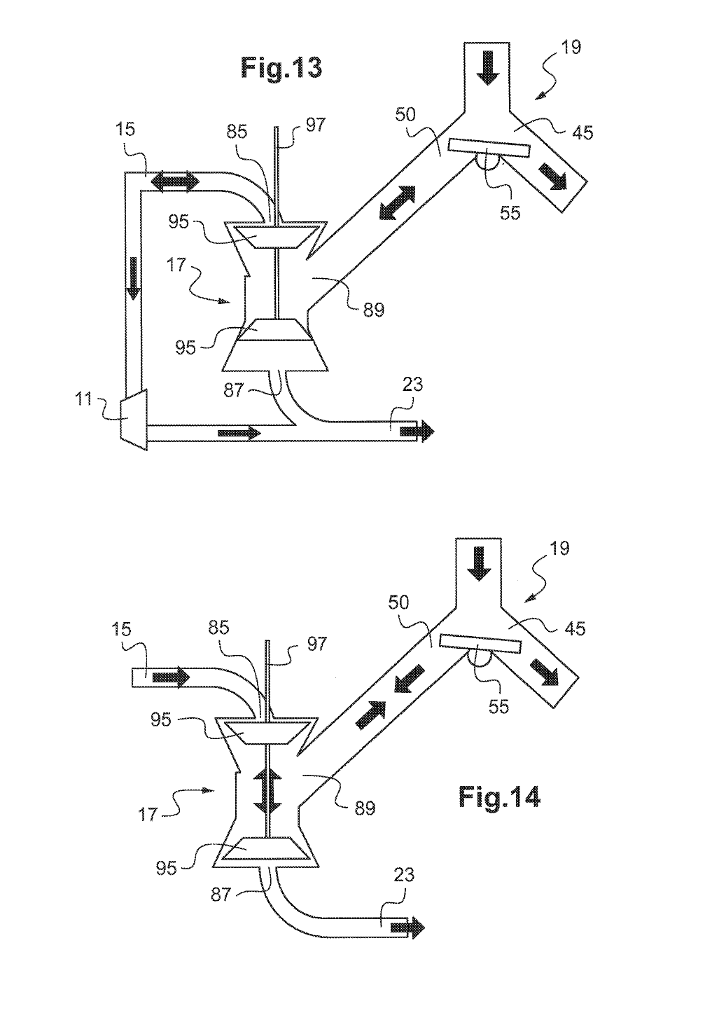

It should be noted that the possible configurations of the gas-orienting device 25 are not limited to the configurations previously described, but also extend to configurations where the position of the moving shutter 55 is in an intermediate position. The discharge valve 17 can be configured accordingly relative to that position of the shutter 55 and the parameters of the engine 1. In particular, the configuration shown in FIG. 13 in which the second opening 87 of the discharge valve 17 is in the closed position and in which the moving shutter 55 is in the intermediate position allows the gases from all of the cylinders 2 to be placed in communication and can allow a supply of the recirculating circuit 7 from the gases from the other cylinders 2a, 2b and 2c so as to obtain a recirculation rate greater than 25%. However, in such a configuration, the distribution of the gases between the recirculating circuit 7 and the turbine 11 of the turbocharger 9 depends on the pressure of the gases in the various ducts of the gas-orienting device 25. Likewise, FIG. 14 shows a configuration in which the shutter 55 is in the intermediate position. In this configuration, the first 85 and second 87 openings are in the open position, which allows the gases from all of cylinders 2 and the exhaust line 23 to be placed in communication such that the distribution of the gases between the recirculation and exhaust is dictated by the pressures of the gases in the various ducts of the orienting device.

Thus, such a system 3 for supercharging the intake gases and recirculating exhaust gases of the engine 1 makes it possible both to recirculate part of the gases, which allows a reduction in pollution, and to supercharge the engine 1, which allows improved efficiency, all while allowing a communication of gases between the supercharging and recirculating circuits.

Thus, the different embodiments of the present invention make it possible to obtain a system 3 for supercharging the intake gases and recirculating the exhaust gases of the engine 1 in which it is possible to control the amount of gas supplying the supercharging and the amount of gas supplying the recirculation, in particular depending on various parameters of the engine to adapt to the different living situations of the engine. Depending on the required power or the amount of oxygen contained in the fresh air received at the intake, for example, the configuration of the system will be adapted to modify the quantity of recirculated gases and the supply of the turbocharger, and thus to avoid any risk of smothering of the engine while maximizing the output and minimizing the pollution created by the engine 1.

1. A system for supercharging the intake gases and recirculating the exhaust gases of an engine, said system comprising:
a supercharging circuit comprising a turbocharger to be driven by the exhaust gases from at least a first cylinder of the engine;
a recirculating circuit for the exhaust gases from at least one second cylinder; and
an exhaust gas-orienting device that is connected to the two circuits and is able to be connected to an exhaust line of the engine so as to control an amount of exhaust gas placed into communication between the supercharging circuit, the recirculating circuit and the exhaust line of the engine.

2. The system according to claim 1, wherein the gas-orienting circuit is connected to the supercharging circuit at a discharge duct of the turbocharger.

3. The system according to claim 1, wherein the exhaust gas-orienting device comprises:
an exhaust gas recirculation valve comprising: a body defining a primary duct designed to be connected to both the outlet of the at least one second cylinder, and to a gas recirculation duct, an auxiliary duct emerging in said primary duct, and means for orienting exhaust gases toward the outlet of the primary duct designed to be connected to said gas recirculation duct and/or toward the auxiliary duct;
a discharge valve comprising a cavity having a first opening designed to be connected to a duct connected to the outlet of the first cylinder, a second opening designed to be connected to the exhaust line, and a third opening connected to the auxiliary duct of the recirculation valve, the discharge valve also comprising first and second means for closing off said first and second openings, respectively, to control the placement in communication of the auxiliary duct with the duct connected to the first and second openings.

4. The system according to claim 3, wherein the exhaust gas-orienting means of the recirculation valve comprise a shutter movable between a full recirculation position preventing the communication between the primary duct and the auxiliary duct and a second position closing off the primary duct, allowing the placement in communication of the primary duct and the auxiliary duct.

5. The system according to claim 1, also comprising an air cooler designed to be situated upstream from the intake of the cylinders of the engine and situated downstream from an intake of the gas recirculating circuit, said cooler being configured to cool and mix the gases received at the inlet to transmit the cold and mixed gases toward the cylinders of the engine.

6. A method for controlling a system according to claim 3, the method comprising:
steering the exhaust gas-orienting device to control an amount of gas placed in communication between the supercharging circuit, the recirculating circuit and the exhaust line of the engine.

7. The control method according to claim 6, wherein the exhaust gas-orienting device is steered based on the parameters of the engine.

8. The control method according to claim 6, wherein the steering of the gas-orienting device comprises the steering of the exhaust gas-orienting means of the recirculation valve and the steering of the first and second closing means of the discharge valve.

9. The method according to claim 8, further comprising orienting, by the orient means, the gases toward the primary duct, and the first closing means close the first opening of the discharge valve so as to isolate the supercharging and gas recirculating circuits relative to one another.

10. The method according to claim 8, further comprising orienting, by the orient means, the gases toward the primary duct wherein the closing means of the discharge valve are in the open position so as to isolate the supercharging and gas recirculating circuits relative to one another and allow a discharge of the gases driving the turbocharger toward the exhaust line.

11. The method according to claim 8, further comprising orienting, by the orient means, the gases toward the auxiliary duct wherein the second closing means of the discharge valve close the second opening so as to isolate the gas-orienting device of the exhaust line and place the gases from the second cylinder in communication with the gases driving the turbocharger, said turbocharger then being driven by the first and second cylinders.

12. The method according to claim 8, further comprising orienting, by the orient means, the gases toward the auxiliary duct, wherein the first closing means of the discharge valve close the first opening so as to isolate the recirculation and supercharging circuits and allow transmission of the gases from the second cylinder toward the exhaust.

13. The method according to claim 8, further comprising orienting, by the orient means, the gases from the second cylinder toward the primary duct, wherein the second closing means of the discharge valve close the second opening so as to isolate the orienting device from the exhaust line and to facilitate the maintenance in the full recirculation position of the exhaust gas-orienting means of the recirculation valve.

14. The method according to claim 8, further comprising orienting, by the orient means, the gases both toward the primary duct and toward the auxiliary duct, wherein the second closing means of the discharge valve close the second opening so as to isolate the orienting device from the exhaust line and place the gases from the second cylinder in communication with the gases driving the turbocharger.
